(19) United States
(12) Patent Application Publication
(10) Pub. No.: US 2013/0343959 A1
(43) Pub. Date: Dec. 26, 2013

(54) COMMON RAIL REDUCTANT INJECTION SYSTEM

(71) Applicants: Michael Golin, Dexter, MI (US); Tim Gardner, Canton, MI (US); Guanyu Zheng, Novi, MI (US); Zhi Ni, Dexter, MI (US)

(72) Inventors: Michael Golin, Dexter, MI (US); Tim Gardner, Canton, MI (US); Guanyu Zheng, Novi, MI (US); Zhi Ni, Dexter, MI (US)

(73) Assignee: TENNECO AUTOMOTIVE OPERATING COMPANY INC., Lake Forest, IL (US)

(21) Appl. No.: 13/529,008

(22) Filed: Jun. 21, 2012

(51) Int. Cl. B01D 53/90

(52) U.S. Cl. 422/170; 422/168; 422/173; 422/169; 422/310

(57) ABSTRACT

An exhaust system including a selective catalytic reduction (SCR) component and an oxidation catalyst component. The exhaust system also includes an exhaust treatment fluid injection system for dispersing an exhaust treatment fluid into an exhaust stream at a location adjacent either the SCR component or the oxidation catalyst component, wherein the exhaust treatment fluid injection device includes a common rail that provides the exhaust treatment fluid under pressure to a plurality of injectors that dose the exhaust treatment fluid into the exhaust stream. The exhaust treatment fluid injection device also includes a return rail for returning unused exhaust treatment fluid to the fluid source.

### FIELD

The present disclosure relates to a reductant injection system for an exhaust system.

### BACKGROUND

This section provides background information related to the present disclosure which is not necessarily prior art.

Emission regulation requirements are mandating that engines have exhaust after-treatment systems to eliminate, or at least substantially minimize, the emission of, for example, particulate matter and NOₓ. To eliminate or reduce the emission of particulate matter and NOₓ, exhaust after-treatment systems can include components such as a particulate filter (e.g., a diesel particulate filter (DPF)), a selective catalyst reduction (SCR) component, and a diesel oxidation catalyst (DOC) component.

SCR and DOC components generally work in conjunction with reductant injection systems that inject a reductant into the exhaust stream to treat the exhaust before the exhaust enters the SCR or DOC components. In the case of SCR, a reductant solution including urea is injected into the exhaust stream before entry into the SCR component. In the case of DOC, a hydrocarbon reductant such as diesel fuel is injected into the exhaust stream before entry into the DOC component.

The injection systems for each of SCR and DOC exhaust after-treatments involve the integration of injectors, pumps, filters, regulators, and other necessary control mechanisms to control the dosing of each of these reductants into the exhaust stream. In general, fluid injection delivery systems for, for example, light, medium, and heavy-duty trucks require only a single injection source for dosing the reductant into the exhaust stream. Large-scale engines for locomotive, marine, and stationary applications, however, can require multiple injector sources for injecting the reductant into the exhaust stream. These large-scale applications, therefore, can be difficult to design to overcome various issues such as maintaining proper injector pressure, system durability, sufficient reductions of harmful emission (e.g., particulate matter and NOₓ), cost, and maintenance.

### SUMMARY

This section provides a general summary of the disclosure, and is not a comprehensive disclosure of its full scope or all of its features.

The present disclosure provides an exhaust system including a selective catalytic reduction (SCR) component and an oxidation catalyst component. The exhaust system also includes an exhaust treatment fluid injection system for dispersing an exhaust treatment fluid into an exhaust stream at a location adjacent either the SCR component or the oxidation catalyst component, wherein the exhaust treatment fluid injection device includes a common rail that provides the exhaust treatment fluid under pressure to a plurality of injectors that dose the exhaust treatment fluid into the exhaust stream. The exhaust treatment fluid injection device also includes a return rail for returning unused exhaust treatment fluid to the fluid source.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically illustrates an exhaust treatment system according to a principle of the present disclosure;

FIG. 2 schematically illustrates a common rail injection system for hydrocarbon injections according to a principle of the present disclosure;

FIG. 3 schematically illustrates a common rail injection system for urea injections according to a principle of the present disclosure; and

FIG. 4 illustrates a large scale exhaust treatment system including the common rail injection systems according to principles of the present disclosure.

Corresponding reference numerals indicate corresponding parts throughout the several views of the drawings.

### DETAILED DESCRIPTION

Example embodiments will now be described more fully with reference to the accompanying drawings.

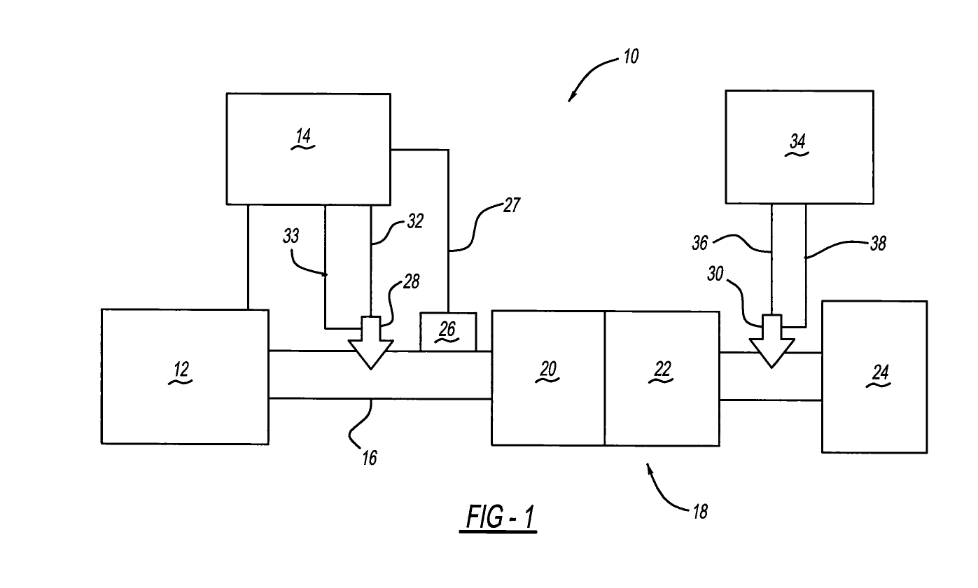

FIG. 1 schematically illustrates an exhaust system 10 according to the present disclosure. Exhaust system 10 includes at least an engine 12 in communication with a fuel source 14 that, once consumed, will produce exhaust gases that are discharged into an exhaust passage 16 having an exhaust after-treatment system 18. Downstream from engine 12 can be disposed a DOC component 20, a DPF component 22, and a SCR component 24. Although not required by the present disclosure, exhaust after-treatment system 18 can further include components such as a burner 26 to increase a temperature of the exhaust gases passing through exhaust passage 16. Increasing the temperature of the exhaust gas is favorable to achieve light-off of the catalyst in DOC and SCR components 20 and 24 in cold-weather conditions and upon start-up of engine 12, as well as initiate regeneration of DPF 22 when required. To provide fuel to burner 26, the burner can include an inlet line 27 in communication with fuel source 14.

To assist in reduction of the emissions produced by engine 12, exhaust after-treatment system 18 can include injectors 28 and 30 for periodically injecting exhaust treatment fluids into the exhaust stream. As illustrated in FIG. 1, injector 28 can be located upstream of DOC 20 and is operable to inject a hydrocarbon exhaust treatment fluid that assists in at least reducing NOₓ in the exhaust stream, as well as raising exhaust temperatures for regeneration of DPF 22. In this regard, injector 28 is in fluid communication with fuel source 14 by way of inlet line 32 to inject a hydrocarbon such as diesel fuel into the exhaust passage 16 upstream of DOC 20. Injector 28 can also be in communication with fuel source 14 via return line 33. Return line 33 allows for any hydrocarbon not injected into the exhaust stream to be returned to fuel source 14. Flow of hydrocarbon through inlet line 32, injector 28, and return line 33 also assists in cooling injector 28 so that injector 28 does not overheat. Although not illustrated in the drawings, injectors 28 can be configured to include a cooling jacket that passes a coolant around injectors 28 to cool them.

Injector 30 can be used to inject an exhaust treatment fluid such as urea into exhaust passage 16 at a location upstream of SCR 24. Injector 30 is in communication with a reductant tank 34 via inlet line 36. Injector 30 also is in communication with tank 34 via return line 38. Return line 38 allows for any urea not injected into the exhaust stream to be returned to tank 34. Similar to injector 28, flow of urea through inlet line 36, injector 30, and return line 38 also assists in cooling injector 30 so that injector 30 does not overheat.

Large-scale diesel engines used in locomotives, marine applications, and stationary applications can have exhaust flow rates that exceed the capacity of a single injector. Accordingly, although only a single injector 28 is illustrated for hydrocarbon injector and only a single injector 30 is illustrated for urea injection, it should be understood that multiple injectors for both hydrocarbon and urea injection are contemplated by the present disclosure. When multiple injectors are used, however, the exhaust system 10 can experience pressure fluctuations at each injector that can affect the spray quality and amount of treatment fluid that is injected into the exhaust stream due to activation/deactivation of the injectors.

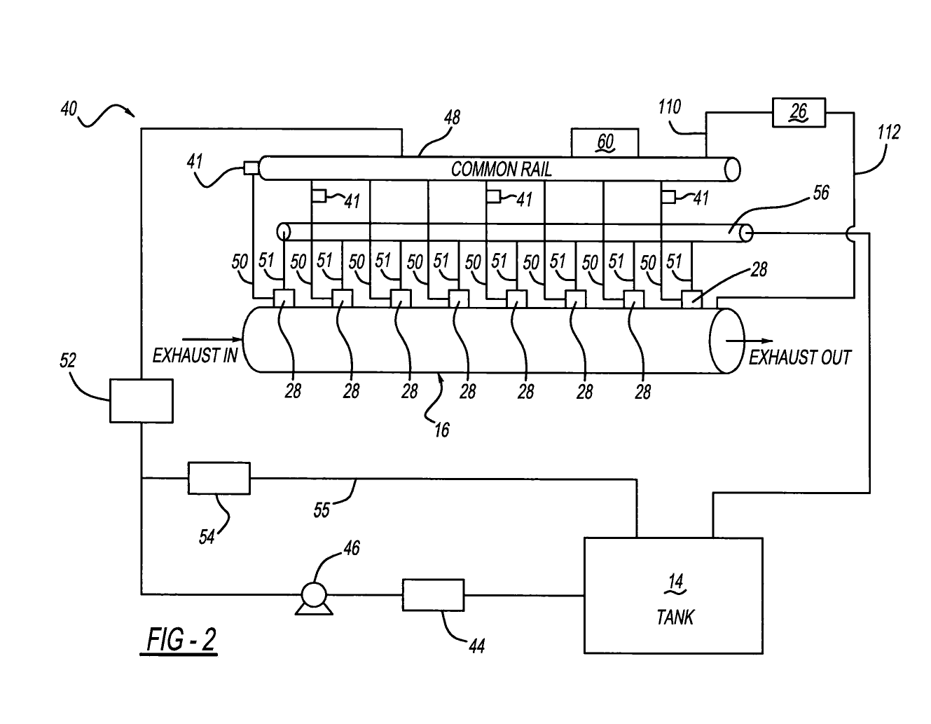

To effectively supply exhaust treatment fluid to the exhaust stream using multiple injectors without sacrificing spray quality and quantity, the present disclosure utilizes a plurality of injectors in fluid communication with a common rail that serves as a distributor of fluid and avoids pressure fluctuations arising from individual injector activations and deactivations. FIG. 2 schematically illustrates a common rail injection system 40 that can be used for supplying a hydrocarbon exhaust treatment fluid to the exhaust stream.

Common rail injection system 40 generally includes fuel source 14, from which a hydrocarbon treatment fluid such as diesel fuel is pumped through a filter 44 by pump 46. Although filter 44 is illustrated as being upstream from pump 46, it should be understood that filter 44 can be located downstream from pump 46 as well without departing from the scope of the present disclosure. Pump 46, in addition to being operable to draw treatment fluid from fuel source 14, is also operable to pressurize common rail 48 and injector inlet lines 50. In the illustrated exemplary embodiment, common rail injection system 40 includes eight injectors 28, with each of the injectors 28 corresponding to a respective exhaust passage 16 of exhaust system 10 for, for example, a diesel powered locomotive. Although eight injectors 28 are illustrated in FIG. 2, it should be understood that more or fewer injectors 28 are contemplated, dependent on the application in which common rail injection system 40 is to be utilized.

Between pump 46 and common rail 48 may be disposed a reducing pressure regulator 52. In general, pump 46 is operable to pump the hydrocarbon treatment fluid at a pressure of about 120 psi, which is greater than a pressure (e.g., approximately 85 psi to 90 psi) in common rail 48 necessary to satisfactorily affect spray quality and quantity. To reduce the pressure in common rail 48, the reducing pressure regulator 52 reduces pressures in common rail 48 to the desired pressure. It should be understood that although the above-noted pressures are desirable, the present disclosure should not be limited thereto. That is, depending on the application size and scope, different pressures can be used and are contemplated, as one skilled in the art will readily acknowledge and appreciate. Regardless, between reducing pressure regulator 52 and pump 46 can be disposed a backpressure regulator 54. Backpressure regulator 54 located upstream from reducing pressure regulator 52 can be used to divert excess flow from pump 46 back to fuel source 14 through overflow line 55. Such a configuration allows pump 46 to run at full capacity without stalling or resonating.

Common rail 48 receives flow from reducing pressure regulator 52 and is designed to maintain constant pressure across all injectors 28. In this regard, a volume of common rail 48 has an effect on pressure fluctuations that occur within common rail 48 as injectors 28 are activated and deactivated, where increasing the volume of common rail 48 decreases pressure fluctuations. Accordingly, a volume of common rail 48 can be tailored according to the specific application in which common rail injection system 40 will be used. When common rail injection system 40 is used in, for example, a locomotive application, common rail 48 can be formed from a stainless steel pipe having an outer diameter ranging between 1.5 to 3 inches, a wall thickness ranging between 0.05 to 0.1 inches, and a length ranging between 96 to 120 inches. Other dimensions for common rail 48, however, are contemplated and would be apparent to one skilled in the art. For example, when common rail 48 is used in a marine or stationary application, the dimensions of common rail 48 can be dimensioned appropriately. To monitor pressures within common rail injection system 40, various pressure sensors 41 can be located at common rail 48 and injectors 28.

The exhaust treatment fluid is fed from common rail 48 into injector inlet lines 50 and then into injectors 28, from which the treatment fluid is then injected into the respective exhaust passages 16. Injectors 28 can also be provided with return lines 51 that each feed into a return rail 56. Return rail 56 can have dimensions similar to or less than common rail 48. Similar to common rail 56, return rail 56 can be dimensioned according to the application for which the injection system is being used.

Although variable, each injector 28 may have a nozzle orifice (not shown) ranging between about 0.01 and 0.05 inches, and an internal return restriction orifice (not shown) ranging between about 0.01 and 0.05 inches. The internal return restriction orifice controls the rate of fluid flowing through injector 28, and provides backpressure for injector 28 to maintain spray quality. The size of nozzle orifice, however, has the greatest effect on droplet size and spray angle during injector dosing. Exhaust treatment fluid present in return rail 56 returns any unused treatment fluid to fuel source 14.

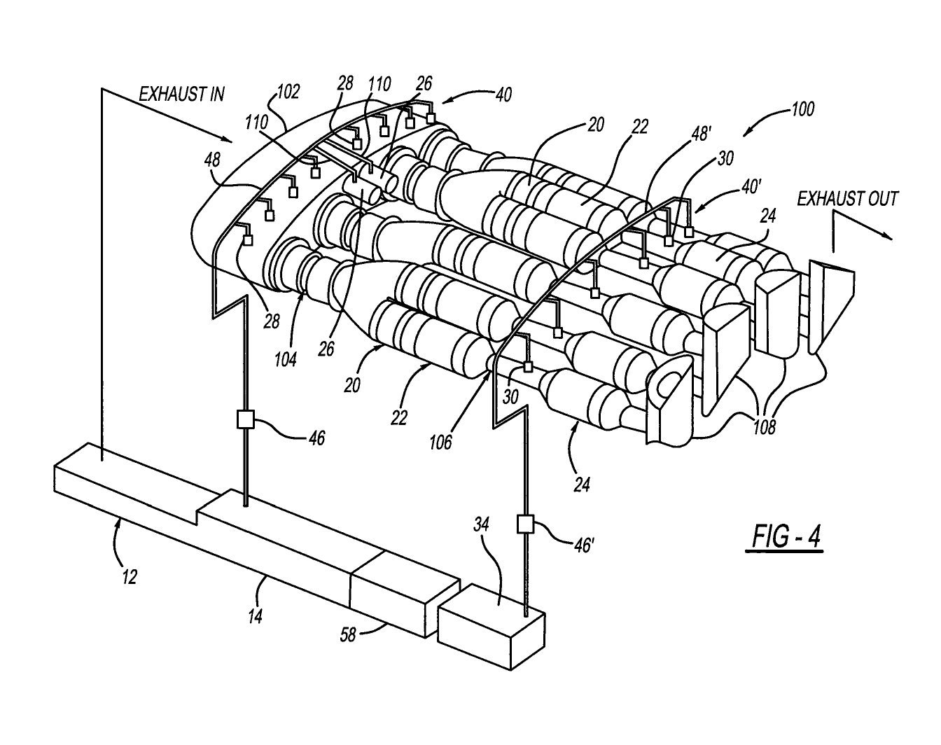

During use of common rail injection system 40, injectors 28 may be activated simultaneously or in a staggered manner. To activate and deactivate injectors 28 either simultaneously or in a staggered manner, common rail injection system 40 can include a controller 58 (FIG. 4) that is operable to control the timing of each injector 28, control pump 46, and monitor pressure sensors 41. Controller 58 may, in turn, be in communication with an engine control unit (not shown) used to control operation of engine 12. Controller 58 is operable to activate injectors 28 in any manner desired. For example, all injectors 28 may be activated simultaneously, or groups of injectors 28 (e.g., groups of two or four) may be activated while the remaining injectors 28 are deactivated.

Although common rail 48 is designed to reduce pressure fluctuations in injectors 28, the activation of all injectors 28 simultaneously can result in various pressure fluctuations at each injector 28. The activation of groups of injectors 28 intermittently, however, negates pressure fluctuations in common rail 48 and, therefore, each injector 28 does not experience pressure fluctuations during staggered activations. Regardless, if simultaneous activation of each injector 28 is desired, common rail 48 can include an accumulator 60. Use of accumulator 60 on common rail 48 assists in reducing pressure fluctuations during simultaneous activation of each injector 28.

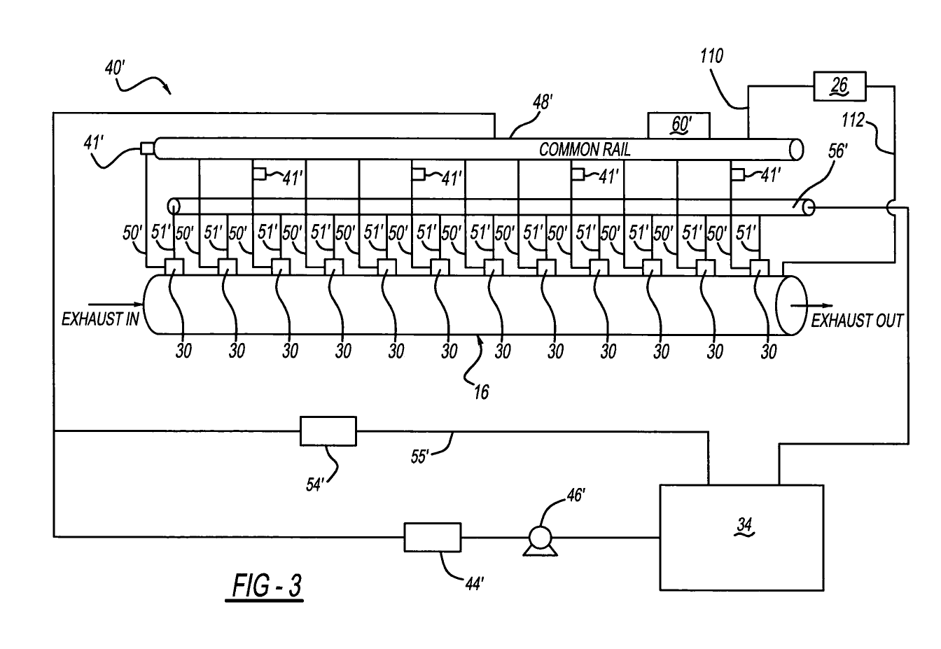

Now referring to FIG. 3, a common rail injection system 40′ is illustrated that is operable to inject a urea exhaust treatment fluid into the exhaust stream. Common rail injection system 40′ is similar to common rail injection system 40, with the largest differences being that twelve injectors 30 are used rather than eight, and that a pump 46′ used to pump urea treatment fluid and pressurize a common rail 48′ and injector inlet lines 50′ is reversible. Pump 46′ is reversible because the urea treatment fluid can freeze. As the urea treatment fluid can freeze, any non-injected urea treatment fluid needs to be purged from common rail injection system 40′ back into tank 34 when common rail injection system 40′ is not in use. An additional difference lies in the manner in how pressure in a common rail 48′ of common rail injection system 40′ is regulated.

Common rail injection system 40′ generally includes urea tank 34 from which a urea treatment fluid is drawn by pump 46′ through filter 44′. Although filter 44′ is illustrated as being downstream from pump 46′, it should be understood that filter 44′ can be located upstream from pump 46′ without departing from the scope of the present disclosure. Pump 46′, in addition to being operable to draw urea treatment fluid from tank 34, is also operable to pressurize common rail 48′ and injector inlet lines 50′. In the illustrated exemplary embodiment, common rail injection system 40′ includes twelve injectors 30. Although twelve injectors 30 are illustrated in FIG. 3, it should be understood that more or fewer injectors 30 are contemplated, dependent on the application in which common rail injection system 40′ is to be utilized.

As noted above, a difference between common rail injection system 40 and common rail injection system 40′ lies in the manner in which the pressure within common rails 48 and 48′ is regulated. In common rail injection system 40′, no reducing pressure regulator is needed to maintain a lower pressure in common rail 48′ in comparison to that which is generated by pump 46′. The reasons that a reducing pressure regulator is not required are that the nozzle orifice (not shown) of injectors 30 is smaller in comparison to that of injectors 28, and that a smaller volume of urea treatment fluid is required to be injected into exhaust system 10 in comparison to the volume of hydrocarbon treatment fluid that may be required. The nozzle orifice (not shown) of injectors 30 is about 0.008 inches and an internal return restriction orifice (not shown) of about 0.024 inches. The nozzle orifice (not shown) of injector 30 is smaller in comparison to the nozzle orifice (now shown) of injector 28 because of the increased atomization required during urea dosing.

Although a reducing pressure regulator is not required for common rail injection system 40′, a backpressure regulator 54′ can still be utilized that is located downstream from pump 46′ to divert excess flow from pump 46′ back to tank 34 through overflow line 55′. Such a configuration allows pump 46′ to run at full capacity without stalling or resonating.

The urea exhaust treatment fluid is fed from common rail 48′ into injector inlet lines 50′ and then into injectors 30, from which the urea treatment fluid is then injected into the respective exhaust passages 16. Injectors 30 can also be provided with return lines 51′ that each feed into a return rail 56′. Similar to injectors 28 for hydrocarbon injection, injectors 30 may require a constant supply of fluid flowing through them to stay cool and function properly. Exhaust treatment fluid present in return rail 56′ returns any unused urea treatment fluid to tank 34.

Like injectors 28, injectors 30 may be activated simultaneously or in a staggered manner. To activate and deactivate injectors 30 either simultaneously or in a staggered manner, common rail injection system 40′ can include a controller 58′ that is operable to control the timing of each injector 30, operate pump 46′, and monitor pressure sensors 41′. Alternatively, in lieu of using a separate controller 58 to control common rail injection system 40′ and if exhaust system 10 is configured to include both common rail injection system 40 and common rail injection system 40′, controller 58 can also be used to simultaneously control common rail systems 40 and 40′. Regardless, controller 58′ (if used) may be in communication with an engine control unit (not shown) used to control operation of engine 12, and controller 58′ is operable to activate injectors 30 in any manner desired. That is, all injectors 30 may be activated simultaneously, or groups of injectors 30 (e.g., groups of two, four, or six) may be activated while the remaining injectors 30 are deactivated. As noted above, activation of groups of injectors can assist in reducing pressure fluctuations in the system. Common rail injection system 40′ can also include an accumulator 60′, if desired.

Because the urea treatment fluid can freeze, common rail injection system 40′ may require purging when not in use. As noted above, pump 46′ is a reversible pump that, when common rail injection system 40′ is not being used, can pump the urea treatment fluid from common rail 48′ and injector inlet lines back into tank 34. Simply running pump 46′ in reverse, however, can sometimes be insufficient to completely purge injector return lines 51′, which leaves the return lines 51′ susceptible to rupture if any urea treatment fluid remains in the return lines during freezing conditions.

To further assist in the purging of the urea treatment fluid from common rail injection system 40′ during non-use thereof, return rail 56′ can be located above common rail 48′. By placing return rail 56′ above common rail 48′ and thus at the highest point in the common rail injection system 40′, gravity can assist in purging the urea treatment fluid from the return lines 51′. More particularly, when return rail 56′ is located above common rail 48, the urea treatment fluid located in return rail 56′ will naturally want to flow back into return lines 51′ when the injection system 40′ is not in use. Further, when pump 46′ is run in reverse to purge injection system 40′, the urea treatment fluid will be pulled from return rail 56′ through return lines 51′ and injectors 30, through inlet lines 50′ and common rail 48′ to tank 34.

Now referring to FIG. 4, an exhaust system 100 for, for example, a locomotive is illustrated including common rail injection systems 40 and 40′. For simplicity, only common rails 48 and 48′ are illustrated in FIG. 4. It should be understood, however, that common rail injection systems 40 and 40′ will also include return rails 56 and 56′ for returning unused hydrocarbon and urea back to fuel source 14 and urea tank 34. Exhaust system 100 includes a diesel-powered engine 12 in communication with a diesel fuel source 14. Engine 12 can feed exhaust into an exhaust turbo manifold 102. At exhaust manifold 102 is disposed common rail injection system 40, which injects hydrocarbon treatment fluid from diesel fuel source 14 into exhaust turbo manifold 102, which is located upstream of DOCs 20. Control of injectors 28 and pump 46 is controlled by controller 58.

Downstream from turbo manifold 102, the exhaust stream is split into a plurality of exhaust passages 104. Each exhaust passage 104 is in communication with an array of a plurality of DOCs 20 and DPFs 22. In the illustrated embodiment, each exhaust passage 104 communicates with an array of three DOCs 20 and three DPFs 22. After exiting the DOCs 20 and DPFs 22, the exhaust stream is passed into exhaust passages 106. At exhaust passages 106, common rail injection system 40′ is disposed where urea treatment fluid is injected into the exhaust stream at a location upstream of SCRs 24 such that after the urea treatment fluid is injected into the exhaust stream at exhaust passages 106, the exhaust stream travels through SCRs 24. After passing through SCRs 24, the treated exhaust exits exhaust system 100 through outlets 108.

As illustrated in FIG. 4, the common rails 48 and 48′ are not embodied by a simple linear pipe. This is because packaging restrictions within the locomotive may prevent the use of such a pipe as the common rails 48 and 48′. Rather, the common rails 48 and 48′ may be modular or curved to account for any packaging restrictions present during design of exhaust system 100. In this regard, common rails 48 and 48′ may include various legs connected together in various orientations to account for the packaging restrictions. The modular design of common rails 48 and 48′ does not significantly affect performance of common rails, including the abatement of pressure fluctuations.

Lastly, as illustrated in FIGS. 2 and 4, exhaust system 100 can include burner 26 for raising temperatures of the exhaust gases, which can raise the catalysts of the DOC 20 and SCR 24 to a light-off temperature. Further, burner 26 is sufficient for raising the exhaust gas temperature to a level sufficient to regenerate DPF 22. To provide fuel to burner 26, burner 26 can be in communication with common rail 48 via a feed line 110 to receive hydrocarbons from injection system 40. Specifically, feed line 110 provides fuel to burner directly from common rail 48. Such a configuration negates the need for a separate inlet line for burner 26 that communicates with fuel source 14, which reduces parts necessary to manufacture exhaust system 100 and also reduces packaging constraints.

As illustrated in FIGS. 2 and 4, burner 26 is located downstream from injectors 28, as indicated by line 112 in FIG. 2 which merely illustrates that burner 26 is directly coupled to exhaust passage 16. It should be understood, however, that burner 26 can be in communication with exhaust passage 16 at a position upstream from injectors 28 so long as burner 26 is located at a position relative to DPFs 22 where burner 26 can raise exhaust temperatures to a point where regeneration of DPF 22 can be achieved.

According to the above, the injection of exhaust treatment fluids for large-scale diesel applications can be effectively administered to the exhaust stream using multiple injectors without sacrificing spray quality and quantity. By using a plurality of injectors in fluid communication with a common rail that serves as a distributor of the fluid, pressure fluctuations arising from individual injector activations and deactivations are avoided. This results in the proper amount and quality of reductant consistently being provided to the exhaust stream to reduce NOₓ from the exhaust stream.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust system, comprising:
a first catalyst component;
a tank for holding an exhaust treatment fluid;
an exhaust treatment fluid injection system for dispersing the exhaust treatment fluid into an exhaust stream at a location adjacent the first catalyst component, the exhaust treatment fluid injection device including a common rail that provides the exhaust treatment fluid under pressure to a plurality of injectors that dose the exhaust treatment fluid into the exhaust stream, and including a return rail for returning unused exhaust treatment fluid to the tank.

2. The exhaust system of claim 1, wherein the exhaust treatment fluid injection system includes a pump for pressurizing the common rail and for pressurizing inlet lines of the injectors.

3. The exhaust system of claim 2, wherein the exhaust treatment fluid injection system includes a backpressure regulator between the pump and the common rail.

4. The exhaust system of claim 1, wherein the exhaust treatment fluid is a hydrocarbon exhaust treatment fluid, the hydrocarbon exhaust treatment fluid being dispersed at a location adjacent the catalyst component.

5. The exhaust system of claim 4, wherein the catalyst component is an oxidation catalyst component.

6. The exhaust system of claim 1, wherein the exhaust treatment fluid is a urea exhaust treatment fluid, the urea exhaust treatment fluid being dispersed at a location adjacent the catalyst component.

7. The exhaust system of claim 6, wherein the catalyst component is a selective catalytic reduction (SCR) catalyst component.

8. The exhaust system of claim 1, further comprising:
a second catalyst component;
a second tank for holding a second exhaust treatment fluid; and
a second exhaust treatment fluid injection system for dispersing the second exhaust treatment fluid into the exhaust stream at a location adjacent the second catalyst component, the second exhaust treatment fluid injection device including a second common rail that provides the second exhaust treatment fluid under pressure to a second plurality of injectors that dose the second exhaust treatment fluid into the exhaust stream, and including a second return rail for returning unused second exhaust treatment fluid to the second tank.

9. The exhaust system of claim 8, wherein the exhaust treatment fluid injection system injects a hydrocarbon treatment fluid at a location adjacent the first catalyst component, and the second exhaust treatment fluid injection system injects a urea treatment fluid at a location adjacent the second catalyst component.

10. The exhaust system of claim 8, wherein the second exhaust treatment fluid injection system includes a second pump for pressurizing the second common rail and for pressurizing inlet lines of the second injectors.

11. The exhaust system of claim 10, wherein the second exhaust treatment fluid injection system includes a backpressure regulator between the second pump and the second common rail.

12. The exhaust system of claim 10, wherein the second pump is reversible such that the second pump is operable to purge the second exhaust treatment fluid from the second exhaust treatment injection system.

13. The exhaust treatment system of claim 1, further comprising a burner to raise a temperature of the exhaust gases.

14. The exhaust treatment system of claim 13, wherein the exhaust treatment fluid is a hydrocarbon exhaust treatment fluid, and the burner uses the hydrocarbon exhaust treatment fluid fed from the common rail as a fuel source.

15. The exhaust treatment system of claim 1, further comprising a particulate filter.

16. An exhaust system including an exhaust after-treatment system, the exhaust after-treatment system comprising:
a first exhaust treatment fluid tank in communication with a first exhaust treatment fluid injection system; and
a second exhaust treatment fluid tank in communication with a second exhaust treatment fluid injection system;
wherein each of the first and second exhaust treatment fluid injection systems include a plurality of injectors for injecting exhaust treatment fluids into an exhaust stream, each of the plurality of injectors being pressurized using a common rail that communicates with each injector through an injector inlet line, and each of the plurality of injectors having an injector return line in communication with a return rail.

17. The exhaust system of claim 16, wherein the first exhaust treatment fluid tank includes a hydrocarbon exhaust treatment fluid.

18. The exhaust system of claim 16, wherein the second exhaust treatment fluid tank includes a urea exhaust treatment fluid.

19. The exhaust system of claim 16, further comprising an oxidation catalyst downstream from the first exhaust treatment fluid injection system.

20. The exhaust system of claim 16, further comprising a selective catalytic reduction (SCR) catalyst downstream from the second exhaust treatment fluid injection system.

21. The exhaust system of claim 16, further comprising a burner, the burner receiving hydrocarbon exhaust treatment fluid from the common rail of the first exhaust treatment fluid injection system.

22. The exhaust system of claim 21, further comprising a particulate filter downstream from the burner.

23. The exhaust system of claim 21, wherein the burner is operable to achieve light-off of a catalyst located downstream from the burner, and is operable to regenerate the particulate filter.

24. An exhaust system, comprising:
a first catalyst component;
a tank for holding an exhaust treatment fluid;
an exhaust treatment fluid injection system for dispersing the exhaust treatment fluid into an exhaust stream at a location adjacent the first catalyst component, the exhaust treatment fluid injection device including a common rail that provides the exhaust treatment fluid under pressure to a plurality of injectors that dose the exhaust treatment fluid into the exhaust stream, and including a return rail for returning unused exhaust treatment fluid to the tank; and
a burner in communication with the exhaust stream for raising a temperature of exhaust gases in the exhaust stream.

25. The exhaust system of claim 24, wherein the exhaust treatment fluid is a hydrocarbon exhaust treatment fluid, the hydrocarbon exhaust treatment fluid being dispersed at a location adjacent the first catalyst component.

26. The exhaust system of claim 24, wherein the first catalyst component is an oxidation catalyst component.

27. The exhaust system of claim 24, wherein the exhaust treatment fluid is a hydrocarbon exhaust treatment fluid, and the burner uses the hydrocarbon exhaust treatment fluid fed from the common rail as a fuel source.

28. The exhaust system of claim 24, further comprising:
a second catalyst component;
a second tank for holding a second exhaust treatment fluid; and
a second exhaust treatment fluid injection system for dispersing the second exhaust treatment fluid into the exhaust stream at a location adjacent the second catalyst component, the second exhaust treatment fluid injection device including a second common rail that provides the second exhaust treatment fluid under pressure to a second plurality of injectors that dose the second exhaust treatment fluid into the exhaust stream, and including a second return rail for returning unused second exhaust treatment fluid to the second tank.

29. The exhaust system of claim 28, wherein the exhaust treatment fluid injection system injects a hydrocarbon treatment fluid at a location adjacent the first catalyst component, and the second exhaust treatment fluid injection system injects a urea treatment fluid at a location adjacent the second catalyst component.

30. The exhaust system of claim 29, wherein the first catalyst component is an oxidation catalyst component, and the second catalyst component is a selective catalyst reduction (SCR) catalyst component.
